(19) United States
(12) Patent Application Publication
(10) Pub. No.: US 2010/0161249 A1
(43) Pub. Date: Jun. 24, 2010

(54) METHOD AND DEVICE FOR TRANSFERRING A LIQUID HAVING A GAS INCLUSION AT LEAST AT TIMES AND FOR DETERMINING THE AMOUNT OF LIQUID TRANSFERRED

(76) Inventors: Alfred Boehm, Viechtach (DE); Wilhelm Binder, Tiefenbach (DE); Dieter Lerach, Zwiesel (DE)

Correspondence Address: JACOBSON HOLMAN PLLC, 400 SEVENTH STREET N.W., SUITE 600, WASHINGTON, DC, 20004, US

(21) Appl. No.: 12/639,230

(22) Filed: Dec. 16, 2009

(30) Foreign Application Priority Data
Dec. 18, 2008 (DE) 10 2008 063 779.3

(51) Int. Cl. G01F 1/00; G06F 19/00

(52) U.S. Cl. 702/47; 702/45

(57) ABSTRACT

The invention relates to a method for transferring a liquid having a gas inclusion at least at times and for determining the amount of liquid transferred, in which the liquid is conveyed through a line, a degree of filling measurement is carried out in the line, a flow measurement is carried out in the line and a calculation, in particular multiplication, is performed on the result of the degree of filling measurement and the result of the flow measurement, whereby a conveyed amount value is obtained. It is thereby provided that the conveyed amount value, which is obtained by performing a calculation on the result of the degree of filling measurement and the result of the flow measurement, is corrected with a value which takes into consideration a dissolution of the gas inclusion in the liquid, whereby a corrected conveyed amount value is obtained, and the corrected conveyed amount value is used as a measure for the liquid amount transferred. The invention further relates to a device for transferring a liquid and for determining the amount of liquid transferred, whereby said device can be designed in particular to implement the method according to the invention.

The invention relates to a method for transferring a liquid having a gas inclusion at least at times, in particular fuel, and for determining the amount of liquid transferred according to the preamble of claim 1. It is provided in such a method that the liquid is conveyed through a line, the degree of filling is measured in the line, a flow measurement is carried out in the line and the result of the degree of filling measurement is entered into a calculation with the result of the flow measurement, in particular being multiplied, whereby a conveyed amount value Vₘₑₛ is obtained.

The invention further relates to devices according to the preamble of claims 13 and 14 for transferring a liquid having a gas inclusion at least at times, in particular fuel, and for determining the amount of liquid transferred. Such devices are formed with a line for conveying the liquid, a degree of filling measuring unit arranged on the line, a flow measuring unit arranged on the line, in particular a pressure measuring unit arranged on the line, and a computing unit which is in signal connection with the degree of filling measuring unit and the flow measuring unit and which is adapted to perform a calculation on measurement results of the degree of filling measuring unit and measurement results of the flow measuring unit, whereby a conveyed amount value Vₘₑₛ is obtained.

In the transfer of liquids, for example in the discharge of heating oil from a tanker vehicle, a situation can arise in which gas inclusions enter the conveying line for the liquid. Such gas inclusions can arise for example if there only remains a low fill height in the discharge tank and as a result of vortex formation in the region of the tank outlet gas is taken along with the liquid. However, gas inclusions can also arise if there are technical failures, for example unsealed pipes, or in case of tampering with the conveying system.

Such gas inclusions can potentially lead to measurement errors, as meters arranged on the conveying line, for example displacement meters, may possibly falsely recognise the gas as product (heating oil) and thus generate an erroneous measurement under certain circumstances. However, according to calibration standards no gas inclusions may be included in the measurement or the measurement error due to gas inclusions must be less than 1% by volume.

In order to comply with the calibration requirements and avoid erroneous measurements on account of gas inclusions, it is known that a gas separator, which can also be described as a gas measurement preventing unit, can be positioned before the meter. These gas separators separate the undesired gas inclusions from the conveying line progression before the gas inclusions reach the meter. A measurement installation with a gas separator is known for example from DE 195 40 884 C2.

The gas separators usually work under the pressure generated by the conveying pump, whereby in the case of installations with a gas separator the product is discharged via the various hoses. It can thereby be provided that the installation can be disconnected if too much gas enters the conveying line and there is a risk of effective gas separation no longer being possible.

Another approach for precisely calibrated determination of the amount of liquid transferred is described in the generic DE 10 2005 005 295 A1. In addition to a flow measurement, this document also teaches the implementation of a degree of filling measurement in the transfer line, thus the determination of the proportion of liquid in the line cross-section. The results of the degree of filling measurement and the flow measurement are entered into a calculation to determine the amount conveyed. According to this approach, gas inclusions are not separated and are instead determined in the measurement and taken into consideration in the calculation of the amount conveyed. A voluminous and heavy gas separator is not therefore needed, meaning that a particularly compact installation can be obtained.

The aforementioned measurement concept is also described in WO 2008/106989 and in the German patent application DE 10 2008 047 122. DE 10 2005 005 295 A1 thereby recognised that the degree of filling can be pressure-dependent, as gas bubbles are highly compressible in contrast with liquids and consequently the volume-based gas portion in the line with the same amount of gas fluctuates with the pressure. The aforementioned documents thus teach that a pressure measurement can be provided in order to determine this effect.

It is an object of the invention to develop a generic method and a generic device, in which the flow is entered into a calculation with the degree of filling in order to determine the amount in such a way as to ensure particularly high measurement precision.

The object is achieved according to the invention by a method having the features of claim 1 and devices having the features of claims 13 and 14. Preferred embodiments are indicated in the dependent claims.

It is provided according to the invention that the conveyed amount value Vₘₑₛ, which is obtained by performing a calculation on the result of the degree of filling measurement and the result of the flow measurement, is corrected with a value which takes into consideration the dissolution of the gas inclusion in the liquid, whereby a corrected conveyed amount value V_{GES} is obtained, and the corrected conveyed amount value V_{GES} is used as a measure for the amount of liquid transferred.

The invention is based upon several surprising discoveries. On the one hand it was observed that in a pump-operated liquid discharge, in which neither a gas separation nor a degree-of-filling-dependent correction of the flow measurement values was provided, in which therefore gas inclusions reached the flow measuring installation without hindrance and without correction, the resulting measurement errors were much lower than would be expected on account of the gas inclusions. In some cases the measurement errors were even so small that, in spite of penetrating air, an adequate measurement precision could be obtained and both the gas separator and the degree of filling measuring unit were dispensable at times.

A further surprising discovery was made when carrying out a measurement method, wherein degree of filling measurements were carried out and the results of the flow measurements were corrected with the results of the degree of filling measurements, in which therefore gas inclusions were determined in the measurement and taken into account in the calculation. Tests were carried out here, in which on the suction side of the conveying pump a defined gas volume was introduced into the liquid. It was thereby shown that the degree of filling sensor arranged on the pressure side of the pump did indeed indicate a volume portion of the gas which was approximately correct corresponding to the pressure increase in the pump. For example with an introduced gas portion of 20% and a pressure difference on the pump of 4 bar, a correct gas portion of 5% was indicated by the degree of filling measuring unit (whereby the relative reduction in the gas portion is due to the fact that the gas volume is compressed with increasing pressure but the liquid volume on the other hand remains approximately constant). However, the theoretically determined volume conveyed, which was obtained by performing a calculation on the results of the flow measurement carried out with a measurement turbine and the results of the degree of filling measurement, was constantly in the region of a few percent greater than the actually conveyed volume.

The invention recognised that the mentioned effects are due to an at least partial dissolution of the gas inclusion in the conveyed liquid. Thus, liquid hydrocarbons, in particular fuels, can take up and hold comparatively large amounts of air in the dissolved state. For example an air quantity of 14% by volume at 1 bar absolute pressure and 20° C. can be dissolved in oils and/or kerosene. In the case of other fuels, this factor can even increase further, for example amounting to 24%, whereby the solubility depends in particular also upon the pressure and the temperature.

Typical transfer devices for liquids thereby frequently have a construction which further supports dissolution of the gas inclusions in the conveyed liquid. The gas inclusion is thus frequently already finely distributed in the suction stroke of the pump, as it is present in the form of a bubble vortex. In the pump which follows in the line progression, whereby this can be in particular a centrifugal pump, the gas inclusion is then further broken up and finely dispersed, whereby this further promotes the dissolution process. Since an increased pressure has built up behind the pump an at least virtually complete dissolution of the gas inclusions can arise under certain circumstances.

Accordingly in a method for transferring a liquid, the gas is frequently at least partially not in a free form which forms air bubbles but is instead bound in the medium in a dissolved form.

The dissolution process of the gas inclusions can influence the measurement of the amount conveyed in several respects. On the one hand the gas which has passed into solution assumes a much smaller volume than the same amount of free, undissolved gas, as the gas molecules in the dissolved state can clearly be arranged more densely than in the free state. In a first approximation the gas which has passed into solution can even frequently be ignored in terms of volume. Its volume portion has thus “disappeared”. At the same time, however, the dissolved gas can under certain conditions continue to be visible as a gas portion in the degree of filling measurement. For this reason, for example, a 5% change in εᵣ in a capacitive degree of filling sensor does not automatically mean that the (free) gas volume portion also correspondingly changes. If, however, the measured degree of filling is simply entered into a calculation with the measured flow, it is assumed that the gas which has actually passed into solution is present in the free form, that is to say a liquid portion is assumed in the line which is smaller than the actual liquid portion. The actually discharged liquid amount is thus greater than the theoretically calculated liquid amount.

As the solubility of the gas generally increases with increasing pressure the actually existing mass of the gas depends not only upon the measured gas volume but also upon the pressure at which it assumes this volume. The aforementioned effect that the amount value obtained by performing a calculation on the degree of filling values and the flow values deviates from the actual volume thus arises in particular if the pressure in the installation changes, for example on account of the pump effect. It is thereby to be considered that the dissolved gas after expansion, thus after a pressure fall, frequently does not leave immediately but instead initially remains for a short time in the liquid and does not expand. Dissolved gas amounts can therefore also influence the measurement if the measurement is carried out in a region in which the pressure is reduced again.

As the mass of the gas additionally depends not only upon the volume but also upon the pressure at which it assumes this volume, the density of the incompressible liquid can also change, which can also lead to errors.

The invention has recognised that dissolution processes of the gas inclusions can lead to the performance of a calculation on the degree of filling results and the flow results leading to a theoretical amount value which does not exactly coincide with the actually discharged amount. The invention steps forth here and teaches that the conveyed amount value obtained by performing a calculation on the degree of filling value and the flow value is not directly used as a measure for the transferred liquid amount. Instead, the value obtained by performing a calculation on the degree of filling measurement and the flow measurement is corrected with a value which takes into consideration a dissolution of the gas inclusion in the liquid. Through this correction a corrected conveyed amount value is obtained which is then output as a transferred liquid amount. A particularly high measurement precision is thus given.

The fact that dissolved gas portions actually play a role in the transfer of fuel was confirmed in a series of trials. For example it was observed that the liquid was completely clear in spite of a portion of 5% by volume of air, whereby this points to a complete dissolution. Furthermore a wet hose was filled with pressure with medium in which a certain amount of air was deliberately mixed, and then the leaving amount was expanded in a balance. It was thereby shown that the liquid volume which ran out of the hose after expansion did not correspond to the volume change of a free gas in the expansion but instead was much lower. It can be concluded from this that a part of the air passed into solution and even after the expansion remained in solution and did not therefore participate in the volume extension and displacement of the liquid out of the hose. The remaining leaving liquid volume can thereby also be due to the fact that the wet hose during filling extended under pressure and resumed its original state again during relaxation. Even in case of complete dissolution of the air a remaining volume can thus leave the hose under certain circumstances.

The liquid which is transferred according to the invention can in particular be fuel, for example heating oil, but can also be milk. The liquid can thus comprise hydrocarbons. The gas inclusion can in particular be an air inclusion. For the degree of filling measurement a degree of filling sensor is usefully provided.

The degree of filling can be understood in particular to be the liquid portion, preferably the relative liquid portion, in the line cross-section. This means in the case of a two-phase system, in which merely liquid and gas are present, that the degree of filling is 100% minus the gas portion in the line cross-section. A degree of filling measuring unit according to the invention therefore measures the liquid content in the line cross-section irrespectively of where the gas inclusions are located and whether an associated boundary area between the liquid and gas is given. For this purpose, capacitive degree of filling measuring units are particularly suitable.

The conveyed amount value can be a volume value but also a conveyance rate value, that is to say a volume per time unit, which must then be integrated for determination of the transferred liquid amount over time.

Insofar as the degree of filling contains the percentage liquid portion in the line cross-section the result of the degree of filling measurement can be multiplied in a particularly simple way by the result of the flow measurement in order to determine the conveyed amount value. Insofar as the degree of filling measurement and the flow measurement take place at different measurement points, it can be ensured through a suitable time function that the values of the degree of filling measurement and the flow measurement, on which a calculation is performed, relate to the same volume portion. It can be provided in this connection that degree of filling measurements are carried out continuously and these are impacted with a “drag indicator function”.

In particular the invention can be used in the discharge of liquid from a tank of a tanker vehicle. However, the invention can also be provided for the filling of the tanker vehicle. In principle, the transfer can take place from any first provision location to any second provision location, whereby the provision locations can in particular be a tank in each case.

In the measuring method according to the invention, air which is located in the measured product or which is mixed in during the discharge process is not separated as in the case of measurement installations with gas separators, but is instead subjected to a calculation in the measurement in such a way that the measurement result complies with the prescribed error limits. It is thereby considered that up to 14% air can be dissolved in mineral oils in dependence upon pressure. For this reason the measured volume is not simply reduced by an air portion. Instead, a correction, in particular a pressure-dependent correction, is initiated, which takes into consideration both the influence of the pressure and the effect of the density which has changed through the air upon the flow measuring unit. This correction balances out the deviation of the volume measurement through air impact and pressure.

It is particularly preferred that the liquid is conveyed by means of a pump through the line whereby the pump causes on its pressure side a pressure increase in the line, the degree of filling measurement is carried out on the pressure side of the pump and the flow measurement is carried out on the pressure side of the pump. According to this embodiment therefore the measurement is carried out in the region of the pressure increase which can typically be up to 8 bar. As explained previously, an increase in the dissolved gas portion can go hand in hand with the pump-related pressure increase, whereby this can lead to the conveyed amount value, obtained by performing a calculation on the gas portion measurement and the flow measurement, being greater than the actually discharged liquid amount. It is therefore preferred that the conveyed amount value Vₘₑₛ, which is obtained by performing a calculation on the result of the degree of filling measurement and the result of the flow measurement, is reduced in order to take into consideration the dissolution of the gas inclusion in the liquid and the corrected conveyed amount value V_{GES} is thus obtained. This embodiment recognises that the actual conveyed amount value is generally lower than the theoretical conveyed amount value, so that V_{GES}<Vₘₑₛ.

In particular the pump can be a centrifugal pump which can be emptied particularly well. An entrainment of liquid in case of a product change and thus product contamination can thus be counteracted.

It is further particularly preferred that for the purpose of flow measurement an indirect volume meter, in particular a turbine meter, is used. A vane meter can also be provided. Such indirect volume meters are also particularly simple to empty, which is advantageous having regard to product purity.

It is particularly advantageous that the degree of filling is measured electrically. In principle, however, an optical measurement is also conceivable. Insofar as an electrical measurement is carried out, this is preferably a capacitance measurement or/and possibly also a conductivity measurement. For a capacitance measurement, electrode plates are usefully provided which are impacted with a temporally variable voltage. The idea behind a capacitive measurement is that gas inclusions generally have a different relative permittivity from the liquid and the relative permittivity of the medium arranged between the plates therefore changes with the gas portion (heating oil has a εᵣ of around 2, air a εᵣ of around 1, whereby the precise value can be pressure-dependent). For the purpose of determining the degree of filling, the capacitance between the electrode plates or a correlated measurement value, for example the relative permittivity, is determined and this is brought into a relationship with the degree of filling through appropriate methods. A degree of filling measuring unit used for the degree of filling measurement can be designed in particular as described in the German utility model DE 20 2004 019 442, in the German patent application DE 10 2005 005 295 A1 and/or in the PCT application WO 2008/106989 A1. The electrical degree of filling measuring unit can in particular comprise a plurality of electrode plates which engage in each other in an inter-digital structure.

The degree of filling measuring unit is preferably arranged upstream, that is to say it is arranged in the line progression before the flow measuring unit in the flow direction.

It is further advantageous that a correction value, in particular a correction volume V_{KL}, is deducted from the conveyed amount value Vₘₑₛ, which is obtained by performing a calculation on the result of the degree of filling measurement and the result of the flow measurement. The correction value V_{KL} can in particular be a correction value for air portions. The corrected conveyed amount value V_{GES}, which corresponds to the total volume conveyed, thus follows from the calculated conveyed amount value Vₘₑₛ and the correction value V_{KL}:

V_{GES}=Vₘₑₛ−V_{KL}

It has surprisingly been shown that particularly accurate measurement values can be obtained in that the conveyed amount volume (Vₘₑₛ), which is obtained by performing a calculation on the result of the degree of filling measurement and the result of the flow measurement, is entered into a calculation with a meter factor (TF) in order to take into consideration the dissolution of the gas inclusion in the liquid. The correction value V_{KL} is usefully determined through the performance of a calculation, in particular multiplication, on the calculated conveyed amount value Vₘₑₛ or/and a measured air volume V_{L} with the meter factor TF. It has surprisingly been shown that the influences of the dissolution process of the gas can hereby be considered in a particularly simple and also exact way. It can thus be provided that:

V_{KL}=TF·Vₘₑₛ

In this case TF reflects the relative deviation between V_{GES} and Vₘₑₛ:

TF=(Vₘₑₛ−V_{GES})/Vₘₑₛ.

The correction value V_{KL} can, however, also be determined by performing a calculation, in particular multiplication, on a measured air volume V_{L} and the meter factor TF, so that:

V_{KL}=TF·V_{L}

Insofar as a turbine meter is used for the flow measurement, the meter factor TF can also be described as a turbine factor. In particular the meter factor TF can be dependent upon the pressure in the line and the signal of the degree of filling measuring unit, thus the degree of filling and the gas portion respectively.

Insofar as the degree of filling measurement and the flow measurement are carried out on the pressure side of a pump, the correction value V_{KL}, which is deducted from the conveyed amount value Vₘₑₛ, and/or the meter factor TF, will generally be positive, as the theoretical conveyed amount value Vₘₑₛ, as explained above, will generally be greater than the actually discharged amount.

It is particularly useful that a pressure measurement is carried out in the line and that the correction value V_{KL} and/or the meter factor TF is/are determined from a result of the pressure measurement and/or a result of the degree of filling measurement. According to this embodiment, the level of the correction is thus made dependent upon the degree of filling or gas portion and pressure measured. Insofar as a pump is provided, the pressure measurement is usefully carried out on the pressure side of the pump in the line. The pressure measurement is preferably carried out in the region of the flow measuring unit and/or the degree of filling measuring unit. In particular a pressure sensor necessary for this can be arranged in the flow direction behind one or both of said measuring units.

According to a further preferred embodiment of the invention, the correction value V_{KL}, which is deducted from the conveyed amount value Vₘₑₛ, is reduced with increasing pressure and/or decreasing measured gas portion to smaller absolute values. It is further advantageous that the meter factor TF is reduced with increasing measured pressure in the line to smaller absolute values.

These embodiments are based upon experiments in which it has surprisingly been shown that a correction value V_{KL}, which decreases with increasing pressure and decreasing gas portion from a positive value in the direction of 0, provides particularly representative measurement values. The pressure and the gas portion are thereby understood to mean the pressure and the gas portion in the line, in particular in the region of the measuring units for degree of filling and flow. The gas portion is usefully determined within the scope of the degree of filling measurement and/or with the degree of filling measuring unit. Insofar as merely a gas phase and a liquid phase are given, the relative gas portion is 100% less the relative degree of filling, i.e. gas portion and degree of filling add up to 100%.

A particularly simple embodiment in terms of calculation is given in that the meter factor is determined by means of a linear function, in which the measured pressure and/or the measured gas portion are entered linearly. In particular the meter factor TF can thus be determined as follows:

TF∝(K·L), in particular TF=K·L

whereby L is the measured gas portion in % and K is a pressure-dependent factor. It has been shown in experiments that it is particularly useful having regard to exact measurement values to select as a pressure-dependent factor K a value which is linearly dependent upon the pressure, whereby K decreases in particular with increasing pressure.

Having regard to the measurement precision it is further particularly advantageous that the meter factor is determined by means of a function which is quadratic in the gas portion L, in which the measured gas portion is entered quadratically and preferably the measured pressure is entered linearly. TF can thus be determined as follows:

TF∝(DF·L²+K·L),

whereby L is the measured air portion in %, DF is a pressure factor and K is a parameter-based factor. It has been shown in experiments that particularly precise measurement results can be obtained if the pressure factor DF is selected as a linear function of the measured pressure, whereby DF decreases with increasing pressure. The parameter-based factor F can be selected to be independent of the pressure and possibly also independent of the installation.

Having regard to measurement precision it is further advantageous that an average value, in particular a volume-weighted average value, is used as the meter factor TF. Accordingly the meter factor TF can be determined as follows:

TF=Σ(TFₐ·V_{T})/Vₐₖₜ,

whereby TFₐ is the current meter factor, V_{T} is the partial volume and Vₐₖₜ is the volume accumulated until the calculation point. In particular the turbine factor can be calculated as a volume-proportional average value, for example at least twice per second, during the discharge.

In addition it is advantageous that during the transfer a plausibility test of individual measurement values, in particular the conveyed amount value or/and the corrected conveyed amount value, is carried out and that the transfer is discontinued if the result does not appear plausible.

It is further useful that the transfer is discontinued if the gas portion determined within the scope of the degree of filling measurement exceeds a certain value, or the degree of filling falls below a certain value. Following the discontinuation, it is preferably provided that the system, in particular the line, is emptied. The invention is indeed based upon the principle that the volume determined within the scope of the flow measurement is corrected using the air value from the degree of filling sensor, so that according to the invention correct measurements can be carried out in principle also with very high gas portions. As the gas inclusions are detected in the measurement according to the invention it is in particular not necessary to reduce the flow speed, for example through regulation of a pump or a valve, if the gas portion increases. If, however, very high gas portions arise, this can point to a system defect, for example a leak, which makes operator intervention necessary. It can thus be advantageous to discontinue the transfer and the measurement if very high gas portions are measured.

It can for example be provided that the transfer and/or the measurement are to be discontinued upon reaching a gas volume portion of around 5% on the pressure side of the pump. In the case of a pressure difference through the pump of 5 bar this corresponds on the suction side to a gas portion of around 25%, as the gas bubbles are reduced in volume through the pressure increase. A suction-side gas portion of 25% is, however, very high and points to a system defect. Even a centrifugal pump would no longer provide a significant conveying power with such a gas portion.

Alternatively or additionally, it can also be provided that the transfer is discontinued, thus the volume flow is interrupted, if the measured degree of filling and/or the measured gas portion reaches a saturation value. According to this embodiment it can be ensured that as far as possible no free air, or only very limited free air, is present on the pressure side of the pump. Indeed, if the gas portion increases so greatly that no further dissolution is possible, the discharge is interrupted. It can thus be ensured that no free air, or only very limited free air, reaches the wet hose. This in turn allows the liquid to be discharged via a wet hose and a liquid volume inside the wet hose to be assumed to be constant during determination of the transferred liquid amount. If the liquid is oil and the gas is air, it is possible for example to discontinue when there is an air portion of 3% at 4 bar and 20° C., whereby this corresponds to an air amount of <14% by volume at 1 bar absolute pressure and 20° C., and approximately reproduces the saturation threshold of air in oils.

In the discharge of liquid with dissolved air via a wet hose, three cases can be distinguished, whereby for the further observations a discharge of the minimum discharge amount is assumed as an example, for instance 200 l, thus the most critical case.

In case 1 the customer receives 200 l without air mixed in. This is the simplest case. After the discharge, the wet hose is completely filled with medium without an air portion. No (air) corrections whatsoever are then necessary.

In the next case 2, the customer receives 200 l with for example 3% air mixed in (at for example 4 bar pump pressure). The customer thereby receives initially around 50 l from the wet hose without an air portion. He then receives 150 l from the system with air mixed in. The air portion of this 150 l is corrected via the degree of filling sensor with the meter factor according to the invention (around 1% of the wet hose volume) and then calculated for the customer together with the approximately 50 l without an air portion from the wet hose. After the end of the discharge the wet hose is filled with air mixed in.

In the next case 3, in the delivery to the next customer with the same hose, the air portion in the wet hose must be considered under certain conditions. Through the dissolution process the air added in case 2 only accounts for around 1% (volume) in the wet hose, that is to say the wet hose has a volume portion of 1% air. With a total hose content of around 50 l, this is only around 0.5 l. This amount must in principle be deducted from the amount to be charged when supplying the customer. Due to the relatively small influence of the air stored in the wet hose upon the total amount to be determined (in the most critical case of the minimum discharge amount) the wet hose content can, however, be assumed in the calculation under certain conditions as fixed at 50 l and not as a parameter-based value.

It is in principle therefore necessary that the volume portion to be assigned to the corresponding hose is considered and if appropriate credited to the next customer. As these amounts can, however, be comparatively small, the hose volume can be assumed as constant under certain conditions. If, instead of a wet hose, a dry hose is used, no calculation of the hose content is necessary as the hose is completely empty at the end of the discharge.

If the amount of air that has entered the wet hose is to be considered, provision can be made to determine said amount of air in time intervals of for example 0.5 s, taking into consideration the respective air portion and the respective interval amount, to evaluate it with the respective meter factor and to intermediately store it for consideration at the time of the next wet hose discharge via the same hose. Therefore, for the next customer, the air portion of the last discharged liquid amount which is contained in the wet hose at the end of the discharge can be registered.

As flow measuring devices, in particular turbine meters, can be dependent upon viscosity and/or temperature, it can be provided that a viscosity correction and/or a temperature correction can be carried out on the measurement values of the flow measurement, in particular before the values are entered into a calculation with the result of the degree of filling sensor.

In the case of a device according to the invention which can be used in particular to implement the method according to the invention, the computing unit is adapted so that the conveyed amount value Vₘₑₛ, which is obtained by performing a calculation on the measurement results of the degree of filling measuring unit and the measurement results of the flow measuring unit, is corrected with a value, in particular a pressure-dependent value, which takes into consideration a dissolution of the gas inclusion in the liquid, whereby a corrected conveyed amount value V_{GES} is obtained. The computing unit is adapted so that the corrected conveyed amount value V_{GES} is output as a measure for the transferred liquid amount. The device can thus determine the portion of the dissolved gas and compensate the measurement result of the turbine meter in a pressure-dependent way.

A fundamental recognition upon which the invention is based consists in that the gas inclusions pass into solution in a pressure-dependent way, whereby this can influence the volume measurement, among other things because the dissolved portions no longer assume the same volume as free portions. In order to counteract measurement inaccuracies potentially arising from this, the previously mentioned embodiments suggest a compensation calculation on the basis of a pressure measurement. An alternative method for taking into consideration the aforementioned aspect, however, consists in that the flow measuring unit, which is provided in addition to the degree of filling measuring unit, is a direct volume meter, in particular a displacement meter. According to this aspect of the invention the dissolution effect is taken into consideration in terms of the equipment. Indeed, a displacement meter measures in a volume-proportionally correct way, that it is say it can suffice to perform a calculation on the results of the displacement meter and the results of the degree of filling measuring unit, whereby a pressure measured in the line can also be brought into the calculation. The degree of filling measuring unit can in this case also be an electrical, in particular a capacitive, degree of filling sensor but also an optical sensor. In order to eliminate the actual air portion by calculation, a degree of filling measuring unit and a pressure sensor are required in this case.

The invention is described in greater detail below by reference to preferred embodiments which are shown schematically in the attached drawings, in which:

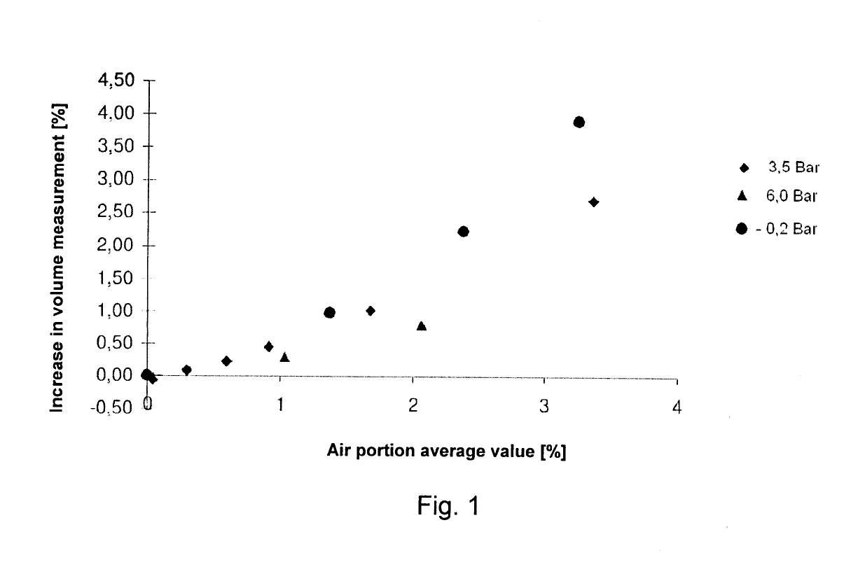

FIG. 1 shows a measurement diagram for a volume measurement with a measurement turbine without the correction of gas dissolution effects according to the invention;

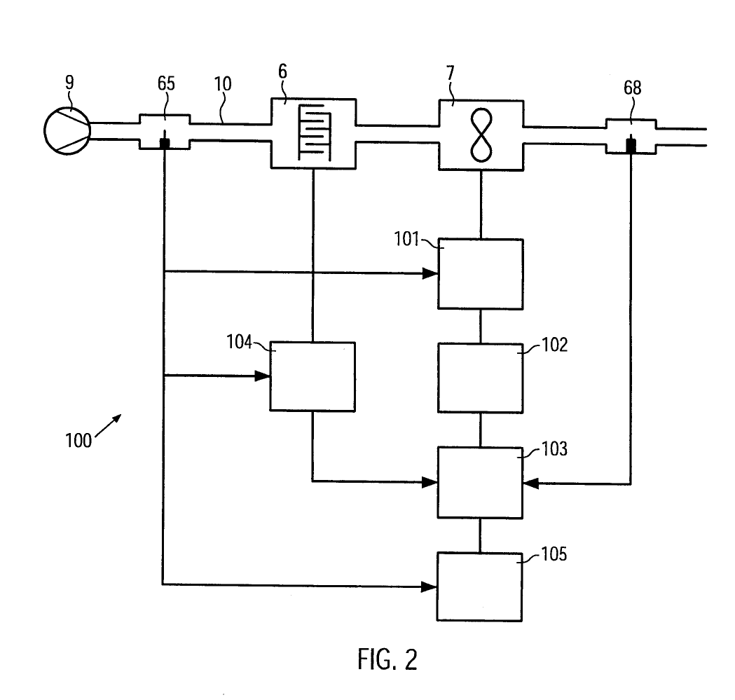

FIG. 2 shows a schematic view of a first embodiment of a device for implementing the method according to the invention;

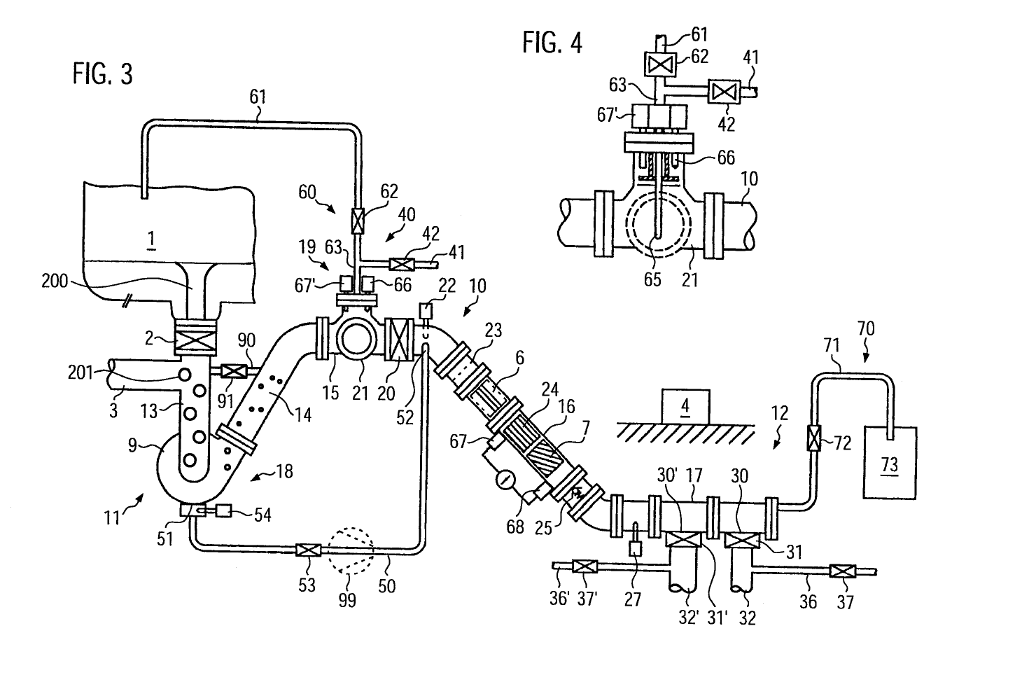

FIG. 3 shows a schematic view of a second embodiment of a device for implementing the method according to the invention, and

FIG. 4 shows a detailed view of the distributor and sensor head of the device of FIG. 3.

Within the scope of the invention, series of measurements were carried out, in which the theoretical transfer volume Vₘₑₛ was determined by performing a calculation on the degree of filling measurement values and flow measurement values without carrying out a correction according to the invention in order to take into consideration the dissolution of gas inclusions in the liquid. These theoretical volumes were compared with the actually transferred volumes. Volume deviations were hereby ascertained whereby the theoretically calculated volume was greater than the actually transferred volume.

Relative volume deviations ascertained within the scope of the series of measurements (increase in volume measurement) are entered in FIG. 1 over the air portion in the line (air portion average value) at different pressures in the line. As shown in FIG. 1, the relative measurement error increased with increasing air portion and decreasing pressure.

The empirically determined increase in the volume measurement, illustrated in FIG. 1, can form the inventive correction factor TF with a negative sign, and this can be used to calculate the corrected volume.

It has been shown that the measurement points of FIG. 1 can be described with a linear approximation, whereby

(increase in volume measurement)=K·(air portion average value)

The factor K, thus the gradient of the individual straight lines, thereby depends linearly upon the pressure and decreases with this pressure.

In case of a linear approximation, therefore, the pressure dependency can be ascertained in the form of two value pairs, which are stored in the measurement system. It has been shown that these values are not system-dependent.

A more accurate modelling of the measurement points “increase in volume measurement” can be obtained through second degree polynomials. In particular the increase can be calculated as follows:

(increase in volume measurement)=DF·(air portion)²+K·(air portion),

whereby DF is a pressure factor which decreases linearly with increasing pressure and K is a parameter-based factor which is generally constant. For a sufficiently accurate approximation, it is merely necessary therefore to vary the factor DF for the quadratic portion in dependence upon the pressure, whereas the factor K can be pressure constant.

For the correction according to the invention of the volume value Vₘₑₛ, which is obtained by performing a calculation on the measurement values of the degree of filling sensor and of the measurement turbine, a quadratic correction calculation can thus be provided. The value determined in the quadratic correction calculation is the actual volume portion in the heating oil, which must now be subtracted with the correct sign from the air-impacted product amount. The quadratic correction can also be correlated in that the measurement result of the turbine is dependent upon the density of the inflowing medium and upon the compressibility of the medium.

A first embodiment of a device for implementing the method according to the invention is shown in FIG. 2. On the pressure side of a pump 9 a line 10 is provided. Arranged along the line 10 at an increasing distance from the pump 9 are a temperature sensor 65, a degree of filling measuring unit 6, a flow measuring unit 7 and a pressure sensor 68. The measuring units 65, 6, 7 and 68 are in signal connection with a computing unit 100 which comprises a plurality of sub-units 101 to 105.

In the sub-unit 101 a viscosity correction of the volume value obtained from the flow measuring unit 7 formed as a measurement turbine is carried out. The viscosity correction takes place in a temperature-dependent way on the basis of the data of the temperature sensor 65 and possibly the respective (predefined) product.

Volume data resulting from the sub-unit 101 are subjected to dynamic linearisation in the sub-unit 102, whereby in particular five correction factors can be provided.

In the sub-unit 104 a temperature correction of the signal of the degree of filling sensor 6 is carried out on the basis of the signal of the temperature sensor 65.

In the sub-unit 103 the viscosity-corrected and dynamically linearised measurement values of the flow measuring unit 7 are entered into a calculation with the temperature-corrected measurement values of the degree of filling sensor 6. At the same time, a gas correction is carried out on the basis of the pressure values of the pressure sensor 68 in order to take into consideration dissolved gas inclusions. In this functional block therefore the measured viscosity-corrected and flow-corrected volume is corrected using the air value from the degree of filling sensor 6.

In the sub-unit 105 the now pure product volume is finally converted to the volume at 15° C.

A further embodiment of a device according to the invention for implementing the method according to the invention is shown in FIG. 3 and in detail in FIG. 4. For the sake of clarity, the computing unit 100 with its sub-units 101 to 105 is not shown in these drawings. The computing unit 100 can, however, be designed in the same way as illustrated in FIG. 2.

According to the embodiment of FIGS. 3 and 4 a tank 1 is provided, on the bottom side of which a tank valve 2 formed as a bottom valve is arranged. By means of the tank valve 2 the tank 1 is in fluid connection with a collecting line 3 which is shown merely in a section in FIG. 3. Further tanks can be arranged on this collecting line 3 via further tank valves.

The device according to the invention comprises a line 10 which is in fluid connection in its tank-side end region 11 with the collecting line 3 and thus with the tank 1. In its opposing, discharge-side end region 12 the line 10 comprises two discharge openings 30, 30′.

The line 10 comprises a series of respectively adjacent line regions 13, 14, 15, 16 and 17 which each have a different orientation in relation to the horizontal. The first line region 13, via which the line 10 is in connection with the tank 1, decreases in height with increasing distance from the tank 1 and the tank-side end region 11. In the embodiment 13 shown, it is shown extending vertically. Connected to the first line region 13 is a second line region 14, in which the line height increases with increasing distance from the tank-side end region 11. Connected to the second line region 14 is a third line region 15 which extends substantially horizontally. Connected to said third line region 15 in turn is a fourth line region 16 which is inclined in relation to the horizontal and in which the line height decreases with increasing distance from the tank-side end region 11. Connected to said fourth line region 16 in turn is a fifth line region 17, in which the line 10 again extends at least virtually horizontally, and in which the discharge-side end region 12 is formed.

Between the first line region 13 and the second line region 14 a lower apex region 18 of the line 10 is formed. The third line region 15 forms an upper apex region 19 of the line 10.

In the lower apex region 18 a pump 9 for conveying liquid from the tank 1 is provided on the line 10. In the further progression of the line 10, thus with increasing distance from the tank-side end region 11, a distributor 21 is provided in the line 10. A line shut-off value 20 connects to said distributor 21 in the further progression of the line 10. A wetting sensor 22 connects in turn to the line shut-off value 20 in the further line progression. The distributor 21, the line shut-off value 20 and the wetting sensor 22 are arranged in the horizontal third line region 15.

In the further progression of the line 10, thus with further increasing distance from the tank-side end region 11, a sieve 23 connects hereto, followed by a degree of filling measuring unit 6, followed by a flow straightener 24, followed by a flow measuring unit 7, followed by a valve 25. The elements 23, 6, 24, 7 and 25 are thereby arranged in the inclined fourth line region 16.

The degree of filling measuring unit 6 works capacitively and comprises a capacitor plate stack arranged in the line cross-section which is used electrically to measure the degree of filling and which can function on the other hand as a flow straightener. The flow straightener 24 is formed as a tube bundle flow straightener. The flow measuring unit 7 is formed as an indirect volume meter, namely as a measurement turbine. The valve 25 is formed as a multi-functional valve which facilitates two flow speeds.

Connected to the valve 25 and to the fourth line region 16 in the further progression of the line 10 at an increasing distance from the tank-side end region 11 are a further wetting sensor 27 and the two discharge openings 30, 30′. The discharge openings 30, 30′ are arranged in the horizontal fifth line region 17. The wetting sensor 27 is preferably also arranged in the horizontal fifth line region 17. A hose connection 32 or 32′ for a wet hose or a dry hose is provided at the discharge openings 30 or 30′ via a respective discharge valve 31 or 31′.

The fourth line region 16 with the measurement section and the second line region 14 are inclined so that these line regions can degas automatically during filling, whereby the gas collects in the intermediately lying third line region 15 in the region of the distributor 21.

In order to degas the installation during filling a vent unit 60 is provided in the third line region 15. The vent unit 60 comprises a vent line 61 which is connected via a common line element 63 to the distributor 21 on the line 10. On its end facing away from the line 10 the vent line 61 runs into the tank 1 or into an intermediate container which is not shown. A vent valve 62 is provided in the progression of the vent line 61.

In order to remove the residue from the installation, i.e. in order to empty the line 10 within the scope of a product change, a feed unit 40 for gas is provided. This feed unit 40 comprises a feed line 41 which is connected to the common line element 63. The feed line 41 is connected to a pressure gas device which is not shown, so that via the feed line 41 on the distributor 21, thus on the third line region 15 and on the upper apex region 19, pressure gas can be brought into the line 10. In order to control the pressure gas supply a valve 42 is provided in the feed line 41.

The device of FIGS. 3 and 4 further comprises a residue removal line 50 which branches from the line 10 at a branch point 51 on the side of the line shut-off valve 20 facing the tank and runs back into the line 10 at a run-in point 52 on the side of the line shut-off valve 20 facing away from the tank. In the region of the branch point 51 a further wetting sensor 54 is provided on the residue removal line 50. In addition a residue removal shut-off valve 53 is provided on the residue removal line 50. A pump 99 can also optionally be arranged in the residue removal line 50.

A compensating line 90 with a valve 91 is provided between the first line region 13 which extends from the tank 1 downwardly towards the pump 9 and the second line region 14 which increases in height towards the feed unit 40. Said compensating line 90 forms a bypass of the lower apex region 18 for the purpose of non-foaming residue removal above the lower apex region 18.

A further wetting sensor 66 is provided on the distributor 21. In addition a temperature sensor 65 for detecting the temperature of the liquid flowing in the line 10 is provided on the distributor 21.

A first pressure sensor 67 is provided between the tank-side end region 11 and the flow measuring unit 7, preferably between the sieve 23 and the flow measuring unit 7, in particular between the degree of filling measuring unit 6 and the flow straightener 24. A further pressure sensor 68 can be provided between the flow measuring unit 7 and the discharge-side end region 12. The pressure sensor 67, possibly in connection with the further pressure sensor 68, can also be used, if the conveying power of the pump 9 and possibly the currently measured flow speed of the product are known, to determine the viscosity and deriving from this accordingly the measurement value for the discharged volume can be corrected. In addition a pressure sensor 67′ for measuring the pressure prevailing in the line 10 is provided on the distributor 21.

On the discharge-side end region 12 of the line 10, in particular on an end plate of the line 10, a further vent unit 70 is provided. This comprises a vent line 71 which is in line connection on the one hand with the line 10 and on the other hand with a container 73. A valve 72 is arranged on said vent line 71.

The device further comprises a preferably two-axis inclinometer 4 which can in particular be fixedly connected to the horizontal part of a tanker vehicle and which can be used to control the vent unit 70.

Arranged on each of the hose connections 32, 32′ is a respective pressure-air-impacted vent line 36, 36′, in which a respective valve 37 or 37′ is arranged.

During operation of the device of FIGS. 3 and 4 the line 10 is firstly filled with gravity until the wetting sensor 66 reacts. The product comprises at this time generally at most negligible portions of dissolved gas. The degassing of the pipeline system during filling takes place through gravity and buoyancy of gas bubbles, whereby departing gas inclusions can be removed via the vent line 61. During the filling the pump 9 may also be operated. The pump 9 does not thereby build up, however, any substantial pressure as the valve 62 of the vent line 61 is open.

After the measurement section has settled and the wetting sensor 66 reports “filling” the vent valve 62 is closed. The degree of filling measuring unit 6 now carries out a first measurement. In addition by means of the temperature sensor 65 a temperature measurement is carried out for compensation purposes.

The corresponding hose valve 31, 31′ is now opened and the pump 9 is activated which builds up the conveying pressure in the line 10. The flow measuring unit 7 which is formed as an indirect flow meter thereby ascertains the current flow. The degree of filling measuring unit 6 continuously ascertains the degree of filling, whereby the measurement values are entered with a time delay into a calculation with the measurement values of the flow measuring unit 7 in order to take into account the distance between the degree of filling measuring unit 6 and the flow measuring unit 7. Averaging of the degree of filling is thereby carried out.

If the fill level in the tank falls, a vortex 200 can form. In the first line region 13 which is arranged on the suction side of the pump 9 and in which an underpressure prevails, bubbles 201 can form as a consequence of the vortex formation. The pump 9 which is preferably formed as a centrifugal pump disperses these bubbles 201 so that the bubbles are dissolved in the second line region 14 on the pressure side of the pump 9. In the region of the degree of filling measuring unit 6 and the flow measuring unit 7 there is thus a product with dissolved air, whereby the partial pressure of the gas is virtually the total pressure.

The occurrence of an air impact is recognised by the degree of filling measuring unit 6 and corrected in terms of calculation also having regard to the pressure.

1. A method for transferring a liquid having a gas inclusion at least at times, in particular fuel, and for determining the amount of liquid transferred, in which
the liquid is conveyed through a line,
a degree of filling measurement is carried out in the line,
a flow measurement is carried out in the line, and
the result of the degree of filling measurement is entered into a calculation, particularly multiplication, with the result of the flow measurement, whereby a conveyed amount value is obtained,
wherein the conveyed amount value, which is obtained by performing a calculation on the result of the degree of filling measurement and the result of the flow measurement, is corrected with a value which takes into consideration a dissolution of the gas inclusion in the liquid, whereby a corrected conveyed amount value is obtained, and
the corrected conveyed amount value is used as a measure for the amount of liquid transferred.

2. The method of claim 1,
wherein the liquid is conveyed through the line by means of a pump, whereby the pump causes a pressure increase on its pressure side,
the degree of filling measurement is carried out on the pressure side of the pump,
the flow measurement is carried out on the pressure side of the pump, and
the conveyed amount value is reduced in order to take into consideration the dissolution of the gas inclusion in the liquid, and the corrected conveyed amount value is thus obtained.

3. The method of claim 1,
wherein an indirect volume meter, in particular a turbine meter, is used to measure the flow.

4. The method of claim 1,
wherein an electrical measurement, in particular a capacitance measurement and/or a conductivity measurement, is carried out in order to measure the degree of filling.

5. The method of claim 1,
wherein a correction value is deducted from the conveyed amount value, which is obtained by performing a calculation on the result of the degree of filling measurement and the result of the flow measurement, and the correction value is determined by performing a calculation, in particular multiplication, on the calculated conveyed amount value or/and a measured air volume with a meter factor.

6. The method of claim 1,
wherein a pressure measurement is carried out in the line, and the correction value and/or the meter factor is/are determined from a result of the pressure measurement and/or a result of the degree of filling measurement.

7. The method of claim 1,
wherein the meter factor is reduced to smaller absolute values with increasing measured pressure in the line and/or decreasing measured gas portion in the line.

8. The method of claim 1,
wherein the meter factor is determined by means of a linear function, in which the measured pressure and/or the measured gas portion are included linearly.

9. The method of claim 1,
wherein the meter factor is determined by means of a function which is quadratic in the gas portion, in which the measured gas portion is included quadratically and/or the measured pressure is included linearly.

10. The method of claim 1,
wherein a volume-weighted average value is used as the meter factor.

11. The method of claim 1,
wherein the transfer is discontinued if the measured degree of filling and/or the measured gas portion reach(es) a saturation value.

12. The method of claim 1,
wherein the liquid is discharged via a wet hose, and a liquid volume inside the wet hose is assumed to be constant during the determination of the amount of liquid transferred.

13. A device for transferring a liquid having a gas inclusion at least at times, in particular fuel, and for determining the amount of liquid transferred, in particular for implementing the method according to one of the preceding claims, with
a line for conveying the liquid,
a degree of filling measuring unit arranged on the line,
a flow measuring unit arranged on the line,
a pressure measuring unit arranged on the line, and
a computing unit which is in signal connection with the degree of filling measuring unit and the flow measuring unit and which is adapted to perform a calculation on measurement results of the degree of filling measuring unit and measurement results of the flow measuring unit, whereby a conveyed amount value is obtained,
wherein the computing unit is adapted so that the conveyed amount value, which is obtained by the performance of a calculation on the measurement results of the degree of filling measuring unit and the measurement results of the flow measuring unit, is corrected with a value, in particular a pressure-dependent value, which takes into account a dissolution of the gas inclusion in the liquid, whereby a corrected conveyed amount value is obtained, and
the computing unit is adapted so that the corrected conveyed amount value is output as a measure for the liquid amount transferred.

14. A device for transferring a liquid having a gas inclusion at least at times, in particular fuel, and for determining the amount of liquid transferred, in particular according to claim 13, with
a line for conveying the liquid,
a degree of filling measuring unit arranged on the line,
a flow measuring unit arranged on the line, and
a computing unit which is in signal connection with the degree of filling measuring unit and the flow measuring unit and which is adapted to perform a calculation on measurement results of the degree of filling measuring unit and measurement results of the flow measuring unit, whereby a conveyed amount value is obtained,
the flow measuring unit is a displacement meter.
